(19) United States
(12) Patent Application Publication
(10) Pub. No.: US 2012/0051088 A1
(43) Pub. Date: Mar. 1, 2012

(54) METHODS OF MANUFACTURING ILLUMINATION SYSTEMS

(75) Inventors: Clarence Chui, San Jose, CA (US); Gaurav Sethi, San Jose, CA (US); Jonathan Charles Griffiths, San Jose, CA (US); Manish Kothari, San Jose, CA (US)

(73) Assignee: QUALCOMM MEMS Technologies, Inc., San Diego, CA (US)

(21) Appl. No.: 12/868,649

(22) Filed: Aug. 25, 2010

(51) Int. Cl. F21V 5/02; H01J 9/00

(52) U.S. Cl. 362/608; 445/23

(57) ABSTRACT

Illumination systems and methods of manufacturing the same. In one embodiment, an illumination system includes a plurality of light sources configured to emit light into a light panel and a plurality of light turning features disposed on the light panel configured to turn light out of the light panel. The light sources can be configured to emit different colors of light than one another and the light turning features can be arranged such that a first light turning feature turns more light having a first color than any other color of light and such that a second light turning feature turns more light having a second color than any other color of light. In another embodiment, a method of manufacturing an illumination system includes providing a light panel and positioning a luminance altering element on the light panel such that a luminance characteristic of the panel changes.

### BACKGROUND

1. Field of the Invention

The invention relates to the field of lighting, and in particular, light extraction in illumination systems.

2. Description of the Related Art

A variety of architectural lighting configurations are utilized to provide artificial illumination in a wide variety of indoor and/or outdoor locations. Such illumination systems can include fixed and portable architectural lighting. Various configurations can employ technologies such as incandescent, fluorescent, and/or light emitting diode based light sources.

One type of architectural lighting configuration can be referred to generally as panel lighting. Panel lights may include, for example, fluorescent lighting in a light box behind a plastic lenticular panel. Panel lighting is often configured as planar and square or rectangular and having width and length dimensions significantly greater than a thickness dimension. While the thickness of panel lighting is generally significantly less than corresponding width and length dimensions, it is frequently the case that the thickness of existing panel lighting forces limitations in installation and use. Display front and backlight techniques can be applied to large area (such as 4′×8′) flat panel lighting.

One specific type of panel lighting is flat panel lighting. Flat panel lights are commonly found in flat panel display applications, which include a transparent panel designed to provide illumination from its planar surface. Light is provided into the panel from a light source (e.g., LEDs or a CCFL lamp), which may be positioned along one or more edges of the panel. Light travels throughout the panel, staying within the panel due to total internal reflection at its front planar surface and back planar surface. At some places on the panel, light may be directed out of the panel by a light extraction or turning feature.

Flat light panels can be sized for luminaire or architectural applications. For architectural applications a panel may be about 4′×8′, or made of tiles of smaller dimensions. Some embodiments include two or more flat light panels adjacently disposed. Thus, flat panel lights can be applied to large areas. Flat panel lights can be used as a luminaire or as a partially transparent light panel and screen. For example, a flat panel light may be used as a privacy screen. The panel can be glass, polymer such as acrylic, polyethylene terephthalate, polycarbonate etc. A 4′×8′ panel may require a thickness of about 0.25″ or greater to allow adequate transmission of light along its width, when illuminated from two edges.

In existing panel designs, light extraction features are often grooves or other features cut into the surface of the panel. However, these machined or embossed features do not facilitate customization of light panels and/or flexibility in illumination system design.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments,” one will understand how the features of this invention provide advantages over other lighting devices.

Certain embodiments of the invention include an illumination system having light turning features configured to extract light input into a light panel from one or more light sources. According to one embodiment, an illumination system includes a light panel having a first surface, a second surface opposite the first surface, a first edge, a second edge, and a third edge. The illumination system also includes a first light source configured to emit light having a first color into the first edge, a second light source configured to emit light having a second color into the second edge, a third light source configured to emit light having a third color into the third edge, a first light turning feature disposed on the first side, the first light turning feature having a first facet configured to turn light toward the second side of the light panel so that at least a portion of the turned light exits the second side of the light panel, the first facet being aligned to turn more light input from the first light source than light input from the second light source or third light source, a second light turning feature disposed on the first side, the second light turning feature having a second facet configured to turn light toward the second side of the light panel so that at least a portion of the turned light exits the second side of the light panel, the second facet being aligned to turn more light input from the second light source than light input from the third light source or first light source, and a third light turning feature disposed on the first side, the third light turning feature having a third facet configured to turn light toward the second side of the light panel so that so that at least a portion of the turned light exits the second side of the light panel, the third facet being aligned to turn more light input from the third light source than light input from the second light source or first light source.

In one aspect, the first color is different from the second color and the second color is different from the third color. In another aspect, the first color is red, the second color is green, and the third color is blue. According to another aspect, the first light turning feature has a first index of refraction characteristic, the light panel has an index of refraction characteristic, and the index of refraction characteristic of the light panel is about the same as the first index of refraction characteristic. In another aspect, the illumination system also includes a coupling layer disposed between at least a portion of the first light turning feature and at least a portion of the light panel. In one aspect, the coupling layer has an index of refraction characteristic that is about the same as the first index of refraction characteristic. In yet another aspect, the second light turning feature has a second index of refraction characteristic and the first index of refraction characteristic is about the same as the second index of refraction characteristic. In one aspect, the third light turning feature has a third index of refraction characteristic that is about the same as the first index of refraction characteristic. In another aspect, the first light turning feature is a prismatic block, the second light turning feature is a prismatic block, and the third light turning feature is a prismatic block. In one aspect, the first light turning feature, second light turning feature, and third light turning feature form a pixel. In another aspect, the light panel includes a plurality of pixels.

According to another embodiment, an illumination system includes a light panel, a first light source, a second light source, a third light source, and a first pixel. The light panel has a first surface, a second surface opposite the first surface, a first edge portion, a second edge portion, and a third edge portion. The first light source is configured to emit light having a first color into the first edge portion, the second light source is configured to emit light having a second color into the second edge portion, and the third light source is configured to emit light having a third color into the third edge portion. The first pixel is configured to turn light input into the light panel from the first light source, second light source, and third light source into the light panel toward the second side. The first pixel includes a first light turning feature including a first facet aligned to turn light input from the first light source, a second light turning feature including a second facet aligned to turn light input from the second light source, and a third light turning feature including a third facet aligned to turn light input from the third light source.

According to one aspect, the first light source is different than the second light source and the second light source is different than the third light source. In one aspect, the first light source is red, the second light source is green, and the third light source is blue.

In another aspect, the first light turning feature is configured to turn more light input from the first light source than light input from the second light source or third light source, the second light turning feature is configured to turn more light input from the second light source than light input from the third light source or first light source, and the third light turning feature is configured to turn more light input from the third light source than light input from the second light source or first light source.

In another aspect, the illumination system includes a second pixel including a fourth light turning feature having a fourth facet aligned to turn light input from the first light source, a fifth light turning feature having a fifth facet aligned to turn light input from the second light source, and a sixth light turning feature having a sixth facet aligned to turn light input from the third light source.

In another embodiment, an illumination system includes a light panel having a first surface, a second surface opposite the first surface, a first edge portion, a second edge portion, and a third edge portion, first means for generating light having a first color, the first light generating means being configured to emit light into the first edge portion, second means for generating light having a second color, the second light generating means being configured to emit light into the second edge portion, third means for generating light having a third color, the third light generating means being configured to emit light into the third edge portion, and pixel means configured to turn light input into the light panel from the first light generating means, second light generating means, and third light generating means toward the second side. The pixel means include first light turning means aligned to turn light input from the first light generating means, second light turning means aligned to turn light input from the second light generating means, and third light turning means aligned to turn light input from the third light generating means.

According to another embodiment, a method of manufacturing an illumination system includes providing a light panel having a first surface, a second surface opposite the first surface, a first edge, a second edge, and a third edge, positioning a first light source configured to emit light having a first color near the first edge of the light panel and aligned to provide light into the light panel through the first edge, positioning a second light source configured to emit light having a second color near the second edge of the light panel and aligned to provide light into the light panel through the second edge, positioning a third light source configured to emit light having a third color near the third edge of the light panel and aligned to provide light into the light panel through the third edge, positioning a first prismatic block on the first surface such that a first facet of the first prismatic block is aligned to turn light emitted by the first light source toward the second surface, positioning a second prismatic block on the first surface such that a second facet of the second prismatic block is aligned to turn light emitted by the second light source toward the second surface, and positioning a third prismatic block on the first surface such that a third facet of the third prismatic block is aligned to turn light emitted by the third light source toward the second surface.

According to one aspect, the first color is different than the second color and the second color is different than the third color. In one aspect, the method includes positioning the first prismatic block, second prismatic block, and third prismatic block to form a pixel that includes the first prismatic block, second prismatic block, and third prismatic block. In another aspect, the method includes bonding the first prismatic block, second prismatic block, and third prismatic block to the light panel with a coupling layer. In one aspect, the first prismatic block has a first index of refraction, the second prismatic block has a second index of refraction that is about the same as the first index of refraction characteristic, the third prismatic block has a third index of refraction characteristic that is about the same as the second index of refraction characteristic, the light panel has an index of refraction characteristic that is about the same as the first index of refraction characteristic, and the bonding agent has an index of refraction characteristic that is about the same as the first index of refraction characteristic.

According to another embodiment, a method of manufacturing an illumination system includes providing a light panel having a first surface, a second surface opposite the first surface, a first edge, and a second edge, the light panel having a first luminance characteristic, and positioning a first luminance altering element on the first surface and a second luminance altering element on the first surface such that the light panel has a second luminance characteristic, wherein the second luminance characteristic is different than the first luminance characteristic.

According to one aspect, the first luminance altering element and second luminance altering element include an element selected from the group consisting of prismatic blocks, glues, adhesives, and bonding agents. In one aspect, the first and second luminance altering elements include prismatic blocks. In another aspect, the method includes positioning a first light source configured to emit light having a first color near the first edge of the light panel, and positioning a second light source configured to emit light having a second color near the second edge of the light panel. In one aspect, the first luminance altering element is configured to turn at least a portion of the light emitted by the first light source toward the second surface and the second luminance altering element is configured to turn at least a portion of the light emitted by the second light source toward the second surface. In another aspect, the first luminance altering element is configured to turn more light emitted by the first light source than light emitted by the second light source, and the second luminance altering element is configured to turn more light emitted by the second light source than light emitted by the first light source

### BRIEF DESCRIPTION OF THE DRAWINGS

Certain example embodiments disclosed herein are illustrated in the accompanying schematic drawings. However, the invention is not limited by the examples, or drawings. Certain aspects of the illustrated embodiments may be simplified or are not shown for clarity of the illustrated features. Also, features described in relation to one embodiment may be included in the other embodiments.

FIG. 1A is a perspective view of an embodiment of a discrete turning feature.

FIG. 1B is a side view of the turning feature of FIG. 1A.

FIG. 2A is a perspective view of an embodiment of an illumination system including the turning feature of FIGS. 1A-1B.

FIG. 2B is a side view of the illumination system of FIG. 2A.

FIG. 3A is a top view of an embodiment of an illumination system having a plurality of discrete turning features.

FIG. 3B schematically illustrates a simulation of light extracted from the illumination system of FIG. 3A.

FIG. 4A is a top view of an embodiment of an illumination system including a plurality of discrete turning features arranged to collectively form an arrow shape.

FIG. 4B schematically illustrates a simulation of light extracted from the illumination system of FIG. 4A.

FIG. 5A is a top view of an embodiment of an illumination system including a first plurality of discrete turning features and a second plurality of discrete turning features.

FIG. 5B schematically illustrates a simulation of light extracted from the illumination system of FIG. 5A.

FIG. 6A is a top view of an embodiment of a pixel element including a plurality of turning features.

FIG. 6B is a top view of an embodiment of an illumination system including a plurality of pixel elements.

FIG. 7 is a block diagram schematically illustrating an embodiment of a method of manufacturing an illumination system.

FIG. 8 is a block diagram schematically illustrating an embodiment of a method of manufacturing an illumination system.

### DETAILED DESCRIPTION OF PREFERRED EMBODIMENTS

The following detailed description is directed to certain specific embodiments of the invention. However, the invention can be embodied in a multitude of different ways. For example, features included in an architectural illumination system can also be included in an illumination system used in a display device. It will be appreciated that the illustrated systems are not necessarily drawn to scale and their relative sizes can differ. Moreover, the relative angles of the facets of the turning features can differ from those illustrated. Furthermore, the cross-sectional areas of the turning features can vary and the relative orientations and angles defined by the facets of the turning features can vary from turning feature to turning feature. In this description, reference is made to the drawings wherein like parts are designated with like numerals throughout.

Illumination systems may include numerous light turning or extraction features cut or embossed into at least one planar surface of the system (e.g., a planar surface of a light panel or light guide). The light turning features may include, for example, grooves, pits, dots, or prismatic features, which are formed as part of the system using traditional monolithic processes (e.g., injection molding or cutting). However, manufacturing processes to provide such features in a light panel can be costly and their use may limit flexibility in design. For example, for light panels that are produced in large batches, it can be difficult to customize the luminance characteristic to suit a particular application. As used herein, “luminance characteristic” refers to the amount of light that passes through or is emitted from a particular area of the light panel, for example, a surface of a light panel or a portion of a surface of a light panel.

To provide more flexibility for light panels to provide custom illumination, discrete light turning features comprising various structures may be added to one or more planar surfaces of a given light panel to extract light in a desired way. For example, discrete turning features can be added to an existing light panel to change the luminance characteristic of the light panel to suit a particular application. In one embodiment, discrete light turning features can be added to an existing light panel to extract light through a particular portion of the light panel and/or to extract more light input into the light panel from a first light source than light input from a second light source. The discrete turning features can include various structures, for example, prismatic blocks, dots, and coupling layers. The systems and methods disclosed herein incorporate discrete turning features to allow for customization of existing light panels.

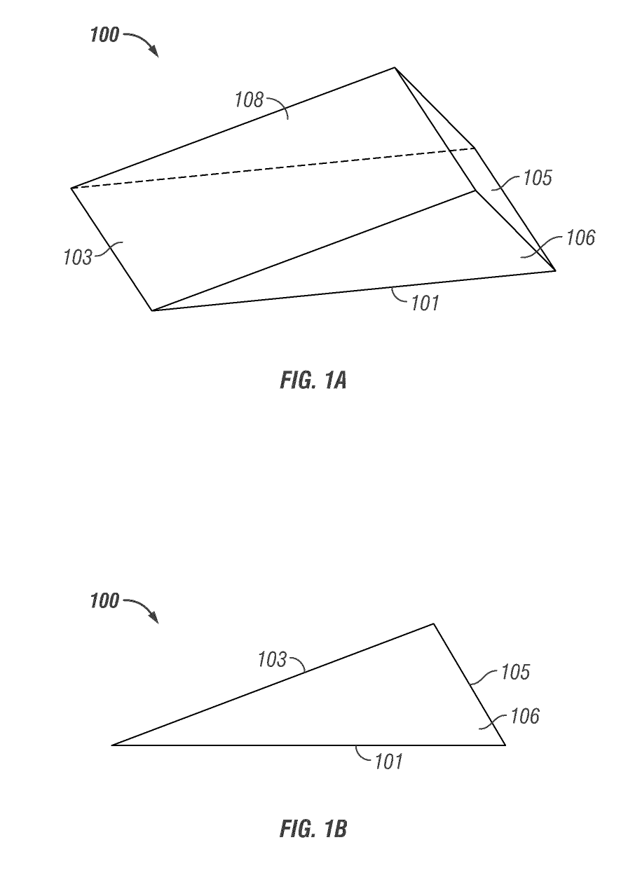

FIGS. 1A and 1B schematically illustrate an embodiment of a discrete turning feature in the form of a prismatic block 100. As discussed in more detail below, the prismatic block 100 can be incorporated, alone or in combination with other discrete turning features, in an illumination system to customize the luminance characteristic of a light panel. In some embodiments, the prismatic block 100 comprises a triangular prism having a generally rectangular bottom surface 101, a first generally rectangular facet 103 extending at an angle relative to the bottom surface from an edge of the bottom surface, a second generally rectangular facet 105 extending at an angle relative to the bottom surface between an edge of the bottom surface and an edge of the first facet, and generally triangular side walls 106, 108 defined by lateral edges of the bottom surface, first facet, and second facet. The prismatic block 100 can comprise various optically transmissive materials, for example, glass, polymer, polycarbonate, polyethylene terephthalate, glycol-modified polyethylene terephthalate, amorphous thermoplastic, and/or other substrates. In some embodiments, the material(s) of the prismatic block 100 can be selected based on an index of refraction characteristic of the material(s). For example, it may be desirable to match an index of refraction characteristic of the block 100 with an index of refraction characteristic of a given light panel.

Some embodiments of the prismatic block 100 can comprise various shapes, for example, generally curvilinear prisms (e.g., spheres), generally polygonal prisms (e.g., pyramids or boxes), and generally polygonal and curvilinear prisms (e.g., hemispheres). In one embodiment, the prismatic block 100 comprises a scalene triangular prism wherein the second facet 105 is smaller than the first facet 103. In this embodiment, an angle formed between the first facet 103 and the bottom surface 101 is less than an angle formed between the second facet 105 and the bottom surface. The surfaces of the prismatic block 100 can be sized and shaped to selectively turn light propagating within the prismatic block toward one or more directions. In one embodiment, the second facet 105 of the prismatic block 100 can be sized and shaped to turn light propagating within the block and the first facet 103 can be sized and shaped to turn less light propagating within the block than the second facet. The second facet 105 can also be oriented and/or aligned to turn more light propagating in a first direction than light propagating in a second direction. Thus, the prismatic block 100 generally may be configured to turn more light propagating from a first direction than light propagating from a second direction that is opposite to the first direction. In some embodiments, the prismatic block 100 can be positioned on a light panel to selectively turn more light propagating from a certain direction than light propagating from another different direction.

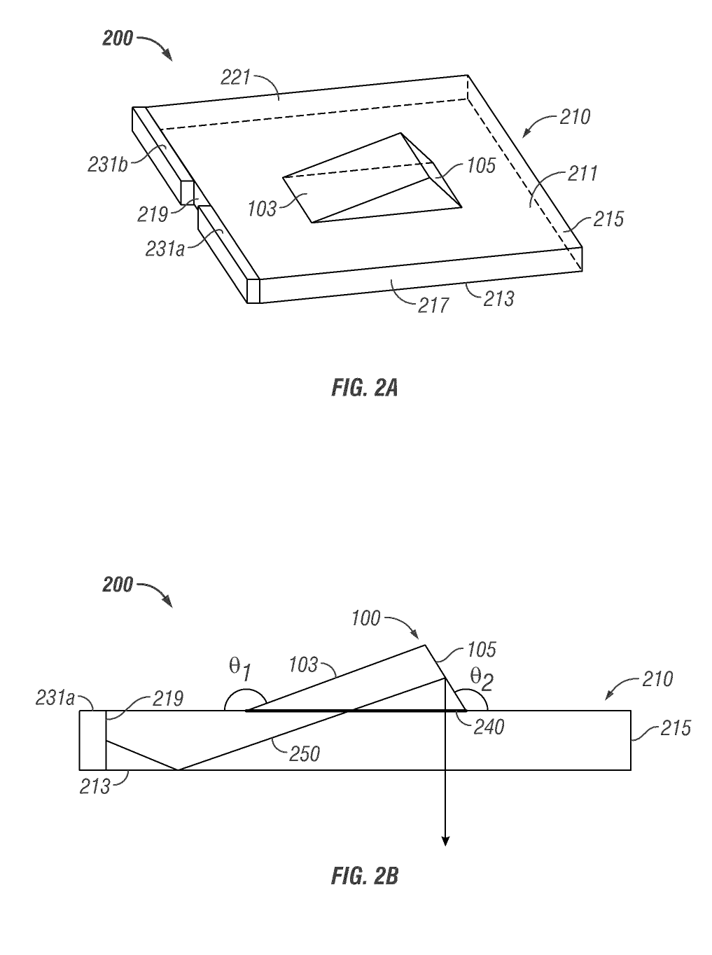

FIG. 2A schematically illustrates an embodiment of an illumination system 200 including the prismatic block 100 of FIGS. 1A and 1B disposed on a light panel 210. The light panel 210 includes a generally planar upper surface 211 and a generally planar lower surface 213 disposed opposite to the upper surface. For clarity of description, the embodiments disclosed herein will generally be described in relation to an upper surface and a lower surface (e.g., as referenced by the relative positions of the illustrated surfaces with respect to page orientation). However, one having ordinary skill in the art will appreciate that the systems can be oriented in any direction during use, including flipped from top-to-bottom and/or side-to-side; accordingly, every embodiment and example described herein with reference to the upper surface can also be implemented on the back surface and vice-versa.

In some embodiments, the upper surface 211 and the lower surface 213 of the light panel 210 may have approximately the same surface area. However, it is possible they could be different in size and/or shape, for example, in embodiments where the first edge 219 and/or the second edge 215 are slanted (e.g., not perpendicular to the upper and lower surfaces 211, 213). In some embodiments, the upper surface 211 and the lower surface 213 can each be about 4′×8′ and they can be generally vertically aligned with one another. The light panel 210 can comprise various optically transmissive materials, for example, glass, polymer, polycarbonate, polyethylene terephthalate, glycol-modified polyethylene terephthalate, amorphous thermoplastic, and/or other substrates. As discussed above, in some embodiments, the light panel can comprise a material with an index of refraction that substantially matches the index of refraction of the prismatic block 100.

With continued reference to FIG. 2A, first and second light sources 231a, 231b can be positioned adjacent to the first edge 219 of the light panel 210. The light sources 231a, 231b can be configured to provide or input light into the light panel 210 at least through the first edge 219. The light sources 231a, 231b may comprise one or more light emitting diodes, fluorescent lights, light bars, or any other suitable light source(s). In some embodiments, the system 200 can include only a single light source and in other embodiments, the system can include more than two light sources. For example, one or more additional light sources can be disposed adjacent to the second, third, and/or fourth edges 215, 217, 221. In embodiments with more than one light source, the light sources can be configured to emit and inject similar or different colors than one another. For example, a first light source could emit red light, a second light source could emit green light, and a third light source could emit blue light. Thus, differently colored rays of light can be injected into the light panel 210 through one or more edges 215, 217, 219, 221.

As schematically depicted in FIG. 2B, the discrete turning feature of FIGS. 1A and 1B can be disposed on the upper surface 211 of the light panel 210 to customize the luminance characteristic of the system 200. In one embodiment, the bottom surface 101 of the turning feature 100 can be secured to a portion of the upper surface 211 of the light panel 210 using a coupling layer 240. The coupling layer 240 can comprise various materials, for example, optical adhesives and/or bonding agents. In some embodiments, the coupling layer can comprise a material with an index of refraction that substantially matches the indices of refraction of the prismatic block 100 and/or light panel 210. In this way, light may propagate from the prismatic block 100 to the light panel 210 through the coupling layer 240 without being substantially refracted or reflected at the boundary between the prismatic block and the coupling layer and/or at the boundary between the coupling layer and the light panel.

Still referring to FIG. 2B, light source 231a can provide light 250 into the first edge 219 of the light panel 210. Light propagating through the panel 210 can be trapped within the panel 210 and/or prismatic block 100 by total internal reflection (“TIR”) until it encounters a light turning facet or surface that is configured to turn light toward the lower surface 213 of the light panel 210. When light propagating within the light panel 210 and prismatic block 100 encounters the second facet 105, some of the light may be turned toward the lower side 213 and extracted from the panel 210 increasing the luminance characteristic of the panel (e.g., making the panel appear brighter to a viewer observing the lower surface 213). As used herein, “extracted” refers to the light that is caused to propagate out of the light panel 210. For example, light 250 can be injected into the light panel 210 by light source 231a and turned toward the lower surface 213 by the second facet 205 of the prismatic block 100. Thus, turning feature 100 can be added to a portion of the light panel 210 to increase the luminance characteristic of a particular portion of the light panel. In other words, one or more turning features 100 can be added to increase the amount of light, input by the light sources 231a, 231b, that is extracted from that portion of the light panel 210). Furthermore, one or more discrete turning features, for example, one or more prismatic blocks 100, can be added to a light panel to affect the uniformity of the luminance characteristic of the light panel. In some embodiments, the uniformity of the luminance characteristic can be controlled by varying the location and/or density of individually placed discrete turning features.

Still referring to FIG. 2B, prismatic block 100 can be configured such that the second facet 105 is configured to turn more light than the first facet 103. Further, the prismatic block 100 can be configured such that the second facet 105 is configured to turn more light propagating from the first edge 219 toward the second edge 215 than light propagating from the second edge toward the first edge. In one embodiment, the first facet 103 forms a first angle θ₁ with the portion of the upper surface 211 between the first edge 219 and the prismatic block 100 and the second facet 105 forms a second angle θ₂ with the portion of the upper surface between the second edge 215 and the prismatic block. In embodiments where the second facet 105 is aligned with the light panel 210 to extract more light than the first facet 103, the second angle θ₂ can be less than the first angle θ₁ such that light that encounters the second facet reflects by TIR toward the lower surface 213 at an angle below the critical angle (e.g., the angle of incidence above which total reflection occurs for a given medium boundary) and propagates out of the light panel. In this configuration, at least a portion of the light incident on the first facet 103 can reflect by TIR toward the lower surface 213 at an angle above the critical angle (relative to the lower surface 213) such that the light does not propagate through the lower surface 213 and instead continues to propagate within the light panel 210 and/or prismatic block 100.

As discussed above, discrete light turning features, for example, the prismatic block 100 of FIGS. 1A-2B, can be used to selectively turn light coming from various different directions. In embodiments where the second facet 105 is aligned with the light panel 210 to extract more light propagating from the first edge 219 toward the second edge 215 than light propagating from the second edge toward the first edge, the second angle θ₂ will be greater than 90°, for example, between about 90° and about 135°. Conversely, in embodiments where the second facet 105 is aligned with the light panel 210 to extract more light propagating from the second edge 215 toward the first edge 219 than light propagating from the first edge toward the second edge, the second angle θ₂ will be less than 90°, for example, between about 90° and about 45°. In this way, discrete turning features can be used to customize the luminance characteristics of various portions of a provided light panel or illumination system.

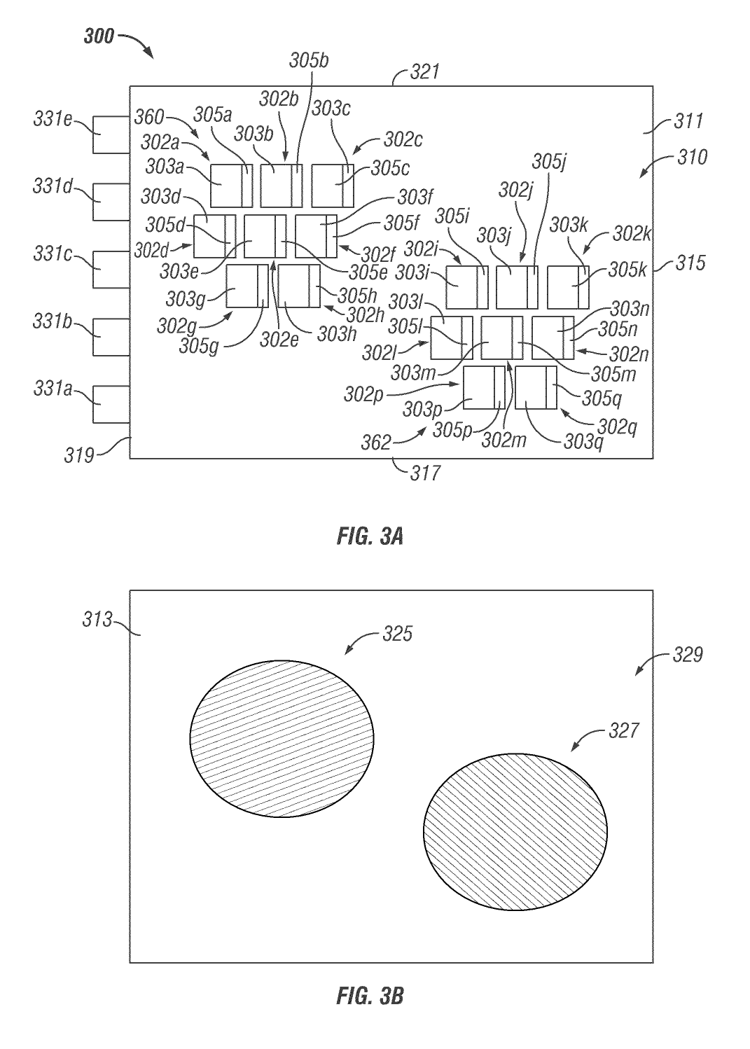

FIG. 3A schematically illustrates a top view of an embodiment of an illumination system 300. The illuminations system 300 includes a first group 360 of prismatic blocks 302a-h and a second group 362 of prismatic blocks 302i-q disposed on a light panel 310. The system 300 further includes a plurality of light sources 331a-e disposed adjacent to the first side 319 of the light panel 310 and configured to inject light into the light panel. Each of the prismatic blocks 302a-q includes a first facet 303a-q and a second facet 305a-q. Similar to prismatic block 100 of FIGS. 1A-2B, prismatic blocks 302a-q are configured such that the second facets 305a-q are configured to extract more light than the first facets 303a-q. The prismatic blocks 302a-q are aligned such that the second facets 305a-q are configured to extract more light propagating from the first side 319 toward the second side 315 than light propagating in any other general direction (e.g., from the second side 315 to the first side 319 or from a fourth side 321 toward a third side 317).

FIG. 3B schematically illustrates a simulation of light extracted through the lower surface 313 of the light panel 310 of FIG. 3A. The lower surface 313 includes first portion 325 having a first luminance characteristic, a second portion 327 having a second luminance characteristic, and a third portion 329 having a third luminance characteristic. The first and second portions 325, 327 correspond to the first and second groups 360, 362 of prismatic blocks 302a-q disposed on the upper surface 311 of the light panel as illustrated in FIG. 3A. Accordingly, the first and second luminance characteristics are greater than the third luminance characteristic as no prismatic blocks 302 or other discrete turning features are disposed on the upper surface 311 over the third portion 329 of the lower surface 313 (e.g., light is not extracted by light turning features 302a-q through the third portion 329). In some embodiments, the luminance characteristics of various portions of the lower surface 313 can be controlled by the placement of discrete turning features on the upper surface 311 of the light panel 310.

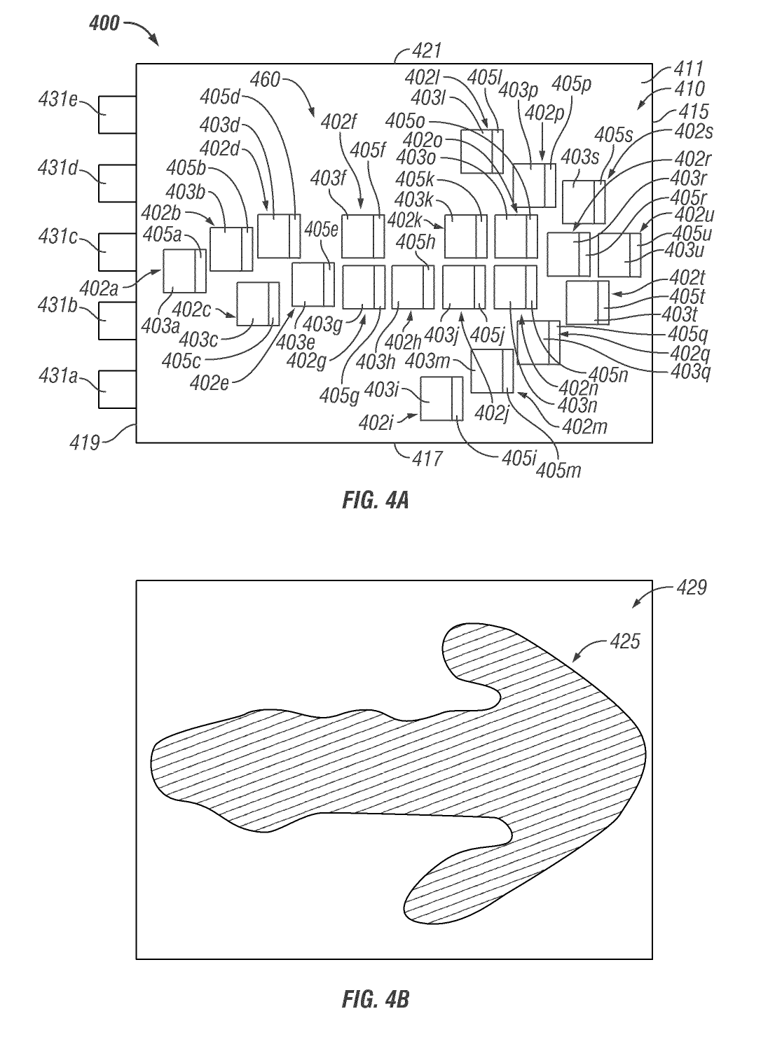

FIG. 4A schematically illustrates a top view of an embodiment of an illumination system 400 which is configured to produce illumination in the form of a desired graphical shape. The illumination system 400 prismatic blocks 402a-u disposed on the upper surface 411 of a light panel 410. The prismatic blocks 402a-u are arranged to collectively form an arrow shaped group 460 (illustrated in FIG. 4B). The system 400 further includes a plurality of light sources 431a-e disposed adjacent to the first side 419 of the light panel 410 and configured to inject light into the light panel. Each of the prismatic blocks 402a-u includes a first facet 403a-u and a second facet 405a-u. Similar to prismatic block 100 of FIGS. 1A-2B, prismatic blocks 402a-u are configured such that the second facets 405a-u are configured to extract more light than the first facets 403a-u. The prismatic blocks 402a-u are aligned such that the second facets 405a-u are configured to extract more light propagating generally from the first side 419 of the light panel 410 toward the second side 415 of the light panel than light propagating in any other general direction (e.g., from the second side to the first side of from the fourth side 421 toward the third side 417).

FIG. 4B schematically illustrates a simulation of light extracted through the lower surface 413 of the light panel 410 of FIG. 4A. The lower surface 413 includes first portion 425 having a first luminance characteristic and a second portion 427 having a second luminance characteristic. The first portion 425 corresponds to the group 460 of prismatic blocks 402a-u disposed on the upper surface 411 of the light panel 410 as illustrated in FIG. 4A. Accordingly, the first luminance characteristic is greater than the second luminance characteristic as no prismatic blocks 402a-u or other discrete turning features are disposed on a portion of the upper surface 411 which is directly over the second portion 425 of the lower surface 413. In some embodiments of illumination systems, discrete turning features can be arranged on a surface of a light panel to collectively form a group having a certain shape such that light extracted from the light panel is extracted through a portion of the light panel that define a shape that substantially matches the shape of the group of turning features.

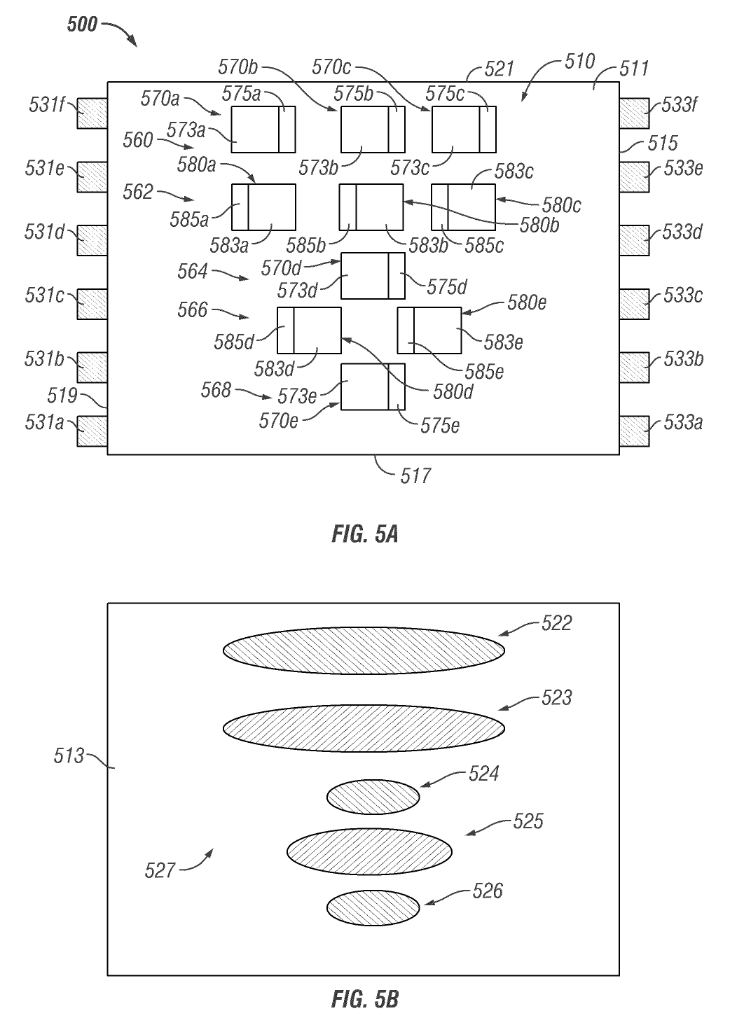

FIG. 5A schematically illustrates a top view of an embodiment of an illumination system 500. The illumination system 500 includes prismatic blocks 570a-e, 580a-e disposed on the upper surface 511 of a light panel 510. Prismatic blocks 570a-c form a first row 560, prismatic blocks 580a-c form a second row 562, prismatic block 570d forms a third row 564, prismatic blocks 580d-e form a fourth row 566, and prismatic block 570e forms a fifth row 568. Rows 560, 562, 562, 566, and 568 are disposed between the first edge 519 and the second edge 515 of the light panel and are positioned sequentially between the fourth edge 521 and the third edge 517 with the first row being nearest to the fourth edge and the fifth row being nearest to the third edge. The system 500 further includes a plurality of light sources 531a-f disposed adjacent to the first edge 519 of the light panel 510 and configured to inject light into the light panel and a plurality of light sources 533a-f disposed adjacent to the second edge 515 of the light panel and configured to inject light into the light panel. In some embodiments, the plurality of light sources 531a-f are configured to emit light having a different color than the plurality of light sources 533a-c. For example, light sources 531a-f can be configured to emit red light and light sources 533a-f can be configured to emit green light.

In some embodiments, each of the prismatic blocks 570a-e includes a first facet 573a-e and a second facet 575a-e. Prismatic blocks 570a-e are configured such that the second facets 575a-e are configured to extract more light than the first facets 573a-e. Prismatic blocks 570a-e are also aligned such that the second facets 575a-e are configured to extract more light propagating generally from the first side 519 of the light panel 510 toward the second side 510 of the light panel than light propagating in any other general direction (e.g., from the second side 510 to the first side 519 or from the fourth side 421 toward the third side 417). In some embodiments, each of the prismatic blocks 580a-e includes a first facet 585a-e and a second facet 583a-e. Prismatic blocks 580a-e are configured such that the second facets 583a-e are configured to extract more light than the first facets 585a-e. In contrast to prismatic blocks 570a-e, prismatic blocks 580a-e are aligned such that the second facets 585a-e are configured to extract more light propagating generally from the second side 515 of the light panel 510 toward the first side 519 side 510 of the light panel than light propagating in any other general direction (e.g., from the first side to the second side of from the fourth side 421 toward the third side 417). In this configuration, the first, third, and fifth rows 560, 564, 568 extract more light input into the light guide 510 from plurality of light sources 531a-f than light input into the light guide from plurality of light sources 533a-f. Similarly, the second and fourth rows 562, 566 extract more light input into the light guide 510 from the plurality of light sources 533a-f than light input from the plurality of light sources 531a-f. In one embodiment, light sources 531a-f emit green light and light sources 533a-f emit red light such that the first, third, and fifth rows 560, 564, 568 extract more green light than red light and the second and fourth rows 562, 566 extract more red light than green light.

FIG. 5B schematically illustrates a simulation of light extracted through the lower surface 513 of the light panel 510 of FIG. 5A. The lower surface 513 includes a first portion 522 having a first luminance characteristic, a second portion 523 having a second luminance characteristic, a third portion 524 having a third luminance characteristic, a fourth portion 525 having a fourth luminance characteristic, a fifth portion 526 having a fifth luminance characteristic, and a sixth portion 527 having a sixth luminance characteristic. The first portion 522 corresponds to the first row 560 of prismatic blocks 570a-c as illustrated in FIG. 5A. The second portion 523 corresponds to the second row 562 of prismatic blocks 580a-c as illustrated in FIG. 5A. The third portion 524 corresponds to the third row 564 formed by prismatic block 575d as illustrated in FIG. 5A. The fourth portion 545 corresponds to the fourth row 566 of prismatic blocks 580d-e as illustrated in FIG. 5A. The fifth portion 526 corresponds to the fifth row 568 formed by prismatic block 575e as illustrated in FIG. 5A. The sixth portion 527 corresponds to the portion of the upper surface 511 as illustrated in FIG. 5A that is not covered by a prismatic block 570a-e, 580a-e. Accordingly, the first, second, third, fourth, and fifth luminance characteristics are greater than the sixth luminance characteristic. Additionally, in embodiments where the plurality of light sources 531a-f emit a different color than the plurality of light sources 533a-f, the first, third, and fifth portions 522, 524, 526 appear as a different color than the second and fourth portions 523, 525. In one embodiment, light sources 531a-f emit green light and light sources 533a-f emit red light such that the first, third, and fifth portions 522, 524, 526 appear green, the second and fourth portions 523, 525 appear red, and the sixth portion 527 appears dark. In some embodiments of illuminations systems, discrete turning features can be aligned relative to a plurality of different color light sources to extract different colors of light through different portions of a light panel.

Illumination systems, for example, architectural lighting configurations, can be configured to display color images from a limited set of primary colors. Many illumination systems include red, green, and blue display elements or sub-pixel elements and other colors can be produced in such a display by varying the relative intensity of light produced by the red, green, and blue elements. Such mixtures of red, green, and blue are perceived by the human eye as other colors. The relative values of red, green, and blue in such a color system can be referred to as tristimulus values in reference to the stimulation of red, green, and blue light-sensitive portions of the human eye. The range of colors that can be produced by a particular display can be referred to as the color gamut of the display. While exemplary color systems based on red, green, and blue are disclosed herein, in other embodiments, illumination systems can include elements or sub-pixels having sets of colors that define other color systems in terms of sets of primary colors other than red, green, and blue, for example, cyan-magenta-yellow systems, red-yellow-blue systems, and violet-orange-green systems.

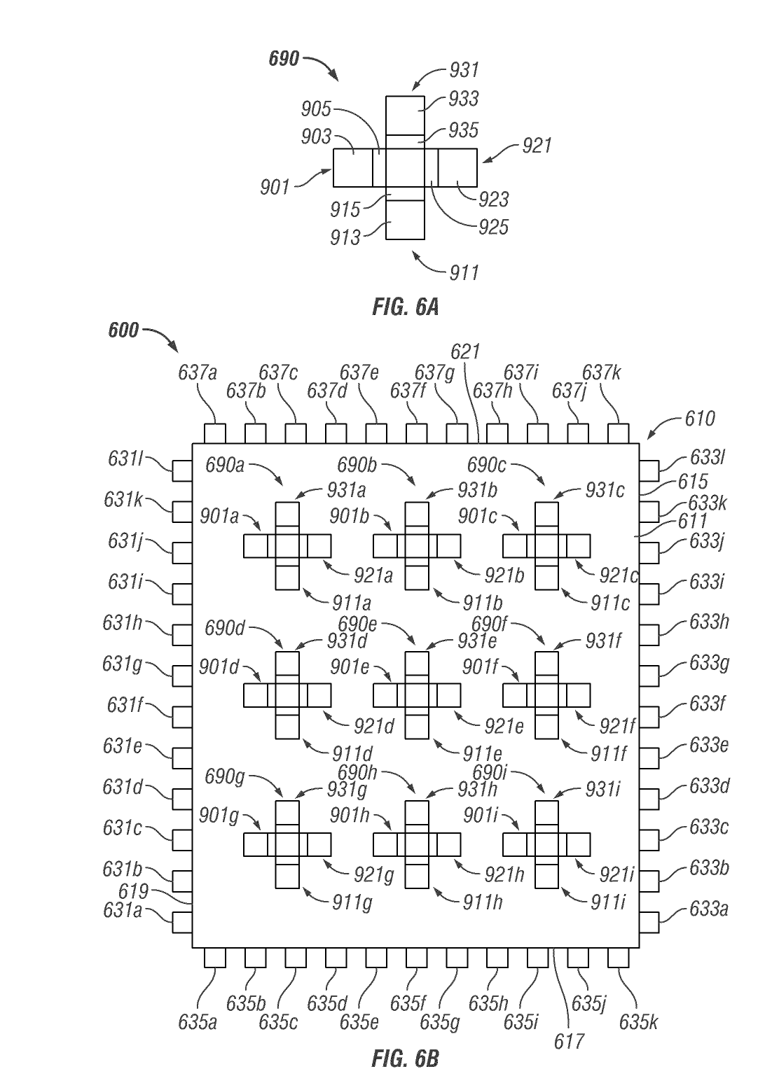

FIG. 6A schematically illustrates a top view of an embodiment of a pixel element 690 formed by four discrete turning features 901, 911, 921, and 931. The turning features 901, 911, 921, and 931 can comprise various structures, for example, prismatic blocks similar to the blocks schematically illustrated in FIGS. 1A-5B, for turning and/or extracting light. In one embodiment, the turning features 901, 911, 921, and 931 each comprise a first facet 903, 913, 923, and 933 and a second facet 905, 915, 925, and 935 configured to turn more light than the first facet. In some embodiments, the second facets 905, 915, 9253, and 935 can be aligned such that the facets turn more light propagating generally in a first direction than light propagating in any other direction. For example, the first turning feature 901 can be aligned and configured such that the second facet 905 is configured to turn more light than the first facet 903 and such that the second facet is aligned to turn more light propagating generally from left to right relative to the pixel element 690 than light propagating in any other general direction. Thus, the turning features 901, 911, 921, and 931 can be positioned and aligned relative to one another such that each turning feature turns more light propagating in a certain direction than in any other direction.

The number of turning features in a pixel element 690 can vary. In some embodiments, a pixel element 690 can comprise between 2 and 20 discrete turning features. The turning features can 901, 911, 921, and 931 be disposed in different configurations relative to one another. For example, the turning features 901, 911, 921, and 931 can be disposed angularly about a center point. In some embodiments, the turning features 901, 911, 921, and 931 are disposed in a symmetric configuration and in other embodiments, the turning features can be disposed in an asymmetric configuration.

FIG. 6B schematically illustrates a top view of an embodiment of an illumination system 600 including a plurality of pixel elements 690a-i disposed on a light panel 610. Each pixel element 690a-i includes four discrete light turning features 901a-i, 911a-i, 921a-i, 931a-i disposed angularly around a common center with about 90° between adjacent turning features. As discussed above with respect to FIG. 6A, each turning feature 901a-i, 911a-i, 921a-i, 931a-i can include a first facet 903a-i, 913a-i, 923a-i, 933a-i and a second facet 905a-i, 915a-i, 925a-i, 935a-i configured to extract more light from the light panel than the first facet. Additionally, the second facets 905a-i, 915a-i, 925a-i, 935a-i can be aligned such that they turn more light propagating in a certain general direction than light propagating in any other general direction. In one embodiment, a first turning feature 901a-i of pixel elements 690a-i can be aligned to turn more light propagating generally from the first edge 619 of the light panel 610 toward the second edge 615 than light propagating in any other general direction. In one embodiment, a second turning feature 911a-i of pixel elements 690a-i can be aligned to turn more light propagating generally from the third edge 617 of the light panel 610 toward the fourth edge 621 than light propagating in any other general direction. A third turning feature 921a-i of pixel elements 690a-i can be aligned to turn more light propagating generally from the second edge 615 of the light panel 610 toward the first edge 619 than light propagating in any other general direction. A fourth turning feature 931a-i of pixel elements 690a-i can be aligned to turn more light propagating generally from the fourth edge 621 of the light panel 610 toward the third edge 617 than light propagating in any other general direction.

The illumination system 600 can include four sets of light sources 631a-l, 633a-l, 635a-k, 637a-k disposed adjacent to the first, second, third, and/or fourth edges 615, 617, 619, 621 of the light panel 610. The light sources 631a-l, 633a-l, 635a-k, 637a-k can be configured to inject light into the light panel 610 through one or more of the first, second, third, and/or fourth edges 615, 617, 619, 621 of the light panel 610. In one embodiment, the first set of light sources 631a-l is disposed adjacent to the first edge 619, the second set of light sources 633a-l is disposed adjacent to the second edge 615, the third set of light sources 635a-k is disposed adjacent to the third edge 617, and the fourth set of light sources 637a-k is disposed adjacent to the fourth edge 621. In some embodiments, each set of light sources 631a-l, 633a-l, 635a-k, 637a-k can be configured to inject a different color of light into the light panel 610. For example, the first set of light sources 631a-l can be configured to inject green light, the second set of light sources 633a-l can be configured to inject red light, the third set of light sources 635a-k can be configured to inject white light, and the fourth set of light sources 637a-k can be configured to inject blue light.

Still referring to FIG. 6B, in embodiments where the light sources 631a-l, 633a-l, 635a-k, 637a-k inject two or more different colors of light, the pixel elements 690a-i can be configured such that a particular color is extracted through the bottom surface of the light panel 610 by the pixel elements. For example, the pixel elements 690a-i can be configured to blend the colors of light input into the light panel 610 and/or to extract a single color input into the light panel by one of the light sources 631a-l, 633a-l, 635a-k, 637a-k. In one embodiment, the pixel elements 690a-i can be configured to extract a particular color by removing one or more of the light turning features 901a-i, 911a-i, 921a-i, and 931a-i from the pixel elements. For example, with light sources 631a-l, 633a-l, 635a-k, 637a-k configured to inject red, green, blue, and white light into the light panel 610, a turning feature in a pixel element 690a-i configured to turn more white light than any other color of light can be removed such that the pixel element 690a-i extracts a blend of light comprising mostly red, green, and blue light from the light panel. In some embodiments, turning features 901a-i, 911a-i, 921a-i, and 931a-i can be dimensioned and/or aligned relative to one another such that the pixel elements 690a-i extract a desired blend of light input by the light sources 631a-l, 633a-l, 635a-k, 637a-k from the light panel 610.

By configuring the pixel elements 690a-i to extract certain colors of light from the light panel 610, the pixel elements can be customizably patterned on a given light panel to create pixilated images on the light panel. For example, a light panel 610 can be provided and pixel elements 690 may be added to the light panel such that the light panel is configured to display a desired image formed by light extracted by the turning features 901, 911, 921, 931 of the pixel elements. In some embodiments, more than one image can be displayed on a light panel 610 by controlling the light sources 631a-l, 633a-l, 635a-k, 637a-k. For example, a first image can be displayed on a light panel 610 when two light sources 631a-l, 633a-l, 635a-k, 637a-k are configured to inject light into the light panel and a second image can be displayed when two different light sources are configured to inject light into the light panel.

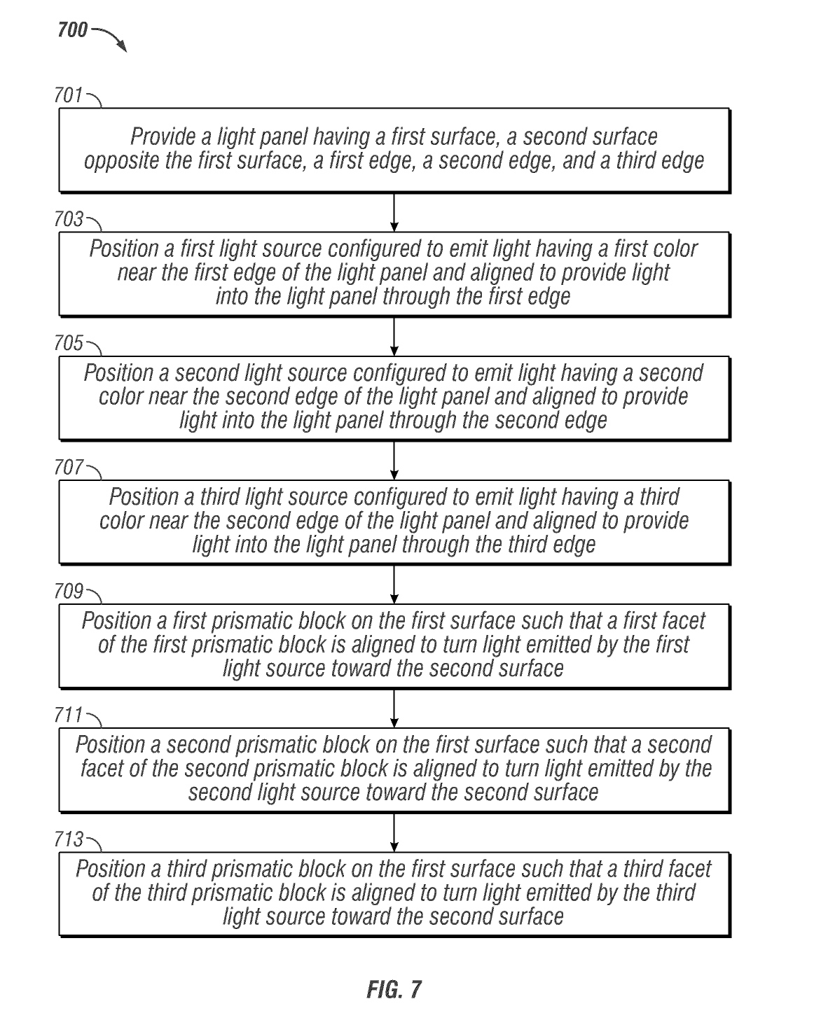

FIG. 7 is a block diagram schematically illustrating an embodiment of a method 700 for manufacturing an illumination system. In some embodiments, an illumination system kit can include a light panel, one or more light sources, and one or more light turning features, as previously described. The light turning features can be positioned on the light panel in a desired configuration relative to one or more light sources attached to the light panel, to produce a desired illumination effect. The turning features can be attached to the light panel using an adhesive having desired optical properties, for example, having an index of refraction that matches or substantially matches the index of refraction of the light turning features or the light panel.

As illustrated in block 701, method 700 includes providing a light panel having a first surface, a second surface opposite the first surface, a first edge, a second edge, and a third edge. In some embodiments, the light panel can be similar to the light panels schematically illustrated in FIGS. 2A-6B. Method 700 further includes positioning a first light source configured to emit light having a first color near the first edge of the light guide and aligned to provide light into the light guide through the first edge as illustrated in block 703. In some embodiments, the first light source can be similar to light sources 631a-l of FIG. 6B. The first light source can comprise one or more light emitting diodes, fluorescent lights, light bars, or any other suitable light source(s). As shown in block 705, method 700 can include positioning a second light source configured to emit light having a second color near the second edge of the light panel and aligned to provide light into the light panel through the second edge. In some embodiments, the second light source can be similar to light sources 633a-l of FIG. 6B. Method 700 can further include positioning a third light source configured to emit light having a third color near the second edge of the light panel and aligned to provide light into the light panel through the third edge as illustrated in block 707. In one embodiment, the third light source can be similar to light sources 637a-k of FIG. 6C. With three light sources positioned near three different edges of the provided light panel, as many as three different colors of light can be injected into the light panel through the edges. When more than one light source is used, the light sources can provide a similar, or different, level of illumination.

To extract the light input by the light sources into the light panel, method 700 can include positioning a first prismatic block on the first surface such that a first facet of the first prismatic block is aligned to turn light emitted by the first light source toward the second source as shown in block 709. The method 700 can further include positioning a second prismatic block on the first surface such that a second facet of the second prismatic block is aligned to turn light emitted by the second light source toward the second surface as shown in block 711. As shown in block 713, method 700 can also include positioning a third prismatic block on the first surface such that a third facet of the third prismatic block is aligned to turn light emitted by the third light source toward the second surface. In some embodiments, the first, second, and third prismatic blocks can have an indices of refraction characteristics that are substantially the same as an index of refraction characteristic of the provided light panel. The three prismatic blocks can be coupled to the first surface of the light panel with a coupling layer that has an index of refraction characteristic that is substantially the same as the indices of refraction characteristics of the prismatic blocks and the index of refraction characteristic of the light panel.

With the three prismatic blocks positioned on the first surface of the light panel, the manufactured illumination system can be configured to extract three different colors of light through different portions of the light panel and/or to extract a blend of three different colors through the light panel. In some embodiments, the manufactured illumination system can be configured to display a symbol, indicia, or pixilated image.

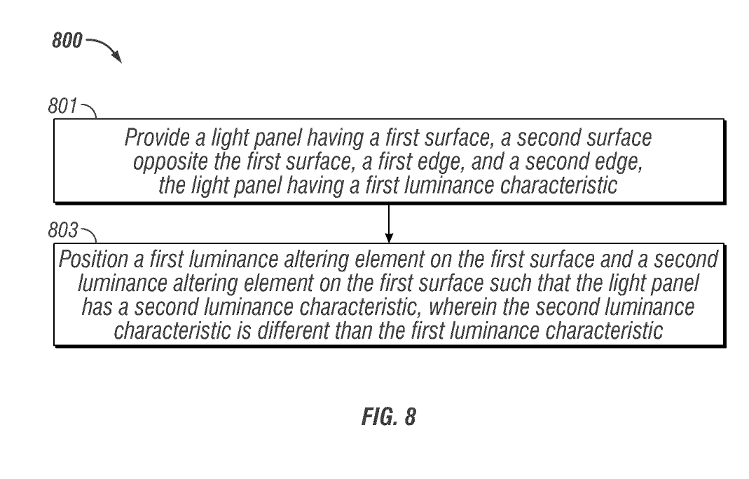

FIG. 8 is a block diagram schematically illustrating an embodiment of a method 800 of manufacturing an illumination system. As illustrated in block 801, method 800 includes providing a light panel having a first surface, a second surface opposite the first surface, a first edge, and a second edge, the light panel having a first luminance characteristic. In some embodiments, the light panel can be similar to the light panels schematically illustrated in FIGS. 2A-6B. As illustrated in block 803, method 800 further includes positioning a first luminance altering element on the first surface and a second luminance altering element on the first surface such that the light panel has a second luminance characteristic, wherein the second luminance characteristic is different than the first luminance characteristic.

In some embodiments of method 800, the first luminance altering element can be a prismatic block, for example, a prismatic block illustrated in FIGS. 1A-6B, glue, adhesive, dot, or bonding agent. The second luminance altering element can also be a prismatic block, glue, adhesive, dot, or bonding agent. The first luminance altering element can be the same as or different than the second luminance altering element. For example, the first and second luminance altering elements can both be prismatic blocks having indices or refraction characteristics that are substantially the same as the index of refraction characteristic of the provided light panel.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. An illumination system comprising:
a light panel having a first surface, a second surface opposite the first surface, a first edge, a second edge, and a third edge;
a first light source configured to emit light having a first color into the first edge;
a second light source configured to emit light having a second color into the second edge;
a third light source configured to emit light having a third color into the third edge;
a first light turning feature disposed on the first side, the first light turning feature having a first facet configured to turn light toward the second side of the light panel so that at least a portion of the turned light exits the second side of the light panel, the first facet being aligned to turn more light input from the first light source than light input from the second light source or third light source;
a second light turning feature disposed on the first side, the second light turning feature having a second facet configured to turn light toward the second side of the light panel so that at least a portion of the turned light exits the second side of the light panel, the second facet being aligned to turn more light input from the second light source than light input from the third light source or first light source; and
a third light turning feature disposed on the first side, the third light turning feature having a third facet configured to turn light toward the second side of the light panel so that so that at least a portion of the turned light exits the second side of the light panel, the third facet being aligned to turn more light input from the third light source than light input from the second light source or first light source.

2. The illumination system of claim 1, wherein the first color is different from the second color.

3. The illumination system of claim 2, wherein the second color is different from the third color.

4. The illumination system of claim 3, wherein the first color is red.

5. The illumination system of claim 4, wherein the second color is green.

6. The illumination system of claim 5, wherein the third color is blue.

7. The illumination system of claim 1, wherein the first light turning feature has a first index of refraction characteristic, wherein the light panel has an index of refraction characteristic, and wherein the index of refraction characteristic of the light panel is about the same as the first index of refraction characteristic.

8. The illumination system of claim 7, further comprising a coupling layer, wherein the coupling layer is disposed between at least a portion of the first light turning feature and at least a portion of the light panel, wherein the coupling layer has an index of refraction characteristic and wherein the index of refraction characteristic of the coupling layer is about the same as the first index of refraction characteristic.

9. The illumination system of claim 7, wherein the second light turning feature has a second index of refraction characteristic, wherein first index of refraction characteristic is about the same as the second index of refraction characteristic.

10. The illumination system of claim 9, wherein the third light turning feature has a third index of refraction characteristic, wherein the first index of refraction characteristic is about the same as the third index of refraction characteristic.

11. The illumination system of claim 10, wherein the first light turning feature is a prismatic block.

12. The illumination system of claim 11, wherein the second light turning feature is a prismatic block.

13. The illumination system of claim 12, wherein the third light turning feature is a prismatic block.

14. The illumination system of claim 13, wherein the first light turning feature, second light turning feature, and third light turning feature form a pixel.

15. The illumination system of claim 14, wherein the light panel comprises a plurality of pixels.

16. An illumination system comprising:
a light panel having a first surface, a second surface opposite the first surface, a first edge portion, a second edge portion, and a third edge portion;
a first light source configured to emit light having a first color into the first edge portion;
a second light source configured to emit light having a second color into the second edge portion;
a third light source configured to emit light having a third color into the third edge portion; and
a first pixel configured to turn light input into the light panel from the first light source, second light source, and third light source into the light panel toward the second side, the pixel comprising
a first light turning feature comprising a first facet aligned to turn light input from the first light source,
a second light turning feature comprising a second facet aligned to turn light input from the second light source, and
a third light turning feature comprising a third facet aligned to turn light input from the third light source.

17. The illumination system of claim 16, wherein the first light source is different than the second light source.

18. The illumination system of claim 17, wherein the second light source is different than the third light source.

19. The illumination system of claim 18, wherein the first light source is red.

20. The illumination system of claim 19, wherein the second light source is green.

21. The illumination system of claim 20, wherein the third light source blue.

22. The illumination system of claim 16, wherein the first light turning feature is configured to turn more light input from the first light source than light input from the second light source or third light source.

23. The illumination system of claim 22, wherein the second light turning feature is configured to turn more light input from the second light source than light input from the third light source or first light source.

24. The illumination system of claim 23, wherein the third light turning feature is configured to turn more light input from the third light source than light input from the second light source or first light source.

25. The illumination system of claim 16, further comprising a second pixel, wherein the second pixel comprises
a fourth light turning feature having a fourth facet aligned to turn light input from the first light source;
a fifth light turning feature having a fifth facet aligned to turn light input from the second light source; and
a sixth light turning feature having a sixth facet aligned to turn light input from the third light source.

26. An illumination system comprising:
a light panel having a first surface, a second surface opposite the first surface, a first edge portion, a second edge portion, and a third edge portion;
first means for generating light having a first color, the first light generating means being configured to emit light into the first edge portion;
second means for generating light having a second color, the second light generating means being configured to emit light into the second edge portion;
third means for generating light having a third color, the third light generating means being configured to emit light into the third edge portion; and
pixel means configured to turn light input into the light panel from the first light generating means, second light generating means, and third light generating means toward the second side, the pixel means comprising
first light turning means aligned to turn light input from the first light generating means,
second light turning means aligned to turn light input from the second light generating means, and
third light turning means aligned to turn light input from the third light generating means.

27. A method of manufacturing a illumination system, the method comprising:
providing a light panel having a first surface, a second surface opposite the first surface, a first edge, a second edge, and a third edge;
positioning a first light source configured to emit light having a first color near the first edge of the light panel and aligned to provide light into the light panel through the first edge;
positioning a second light source configured to emit light having a second color near the second edge of the light panel and aligned to provide light into the light panel through the second edge;
positioning a third light source configured to emit light having a third color near the third edge of the light panel and aligned to provide light into the light panel through the third edge;
positioning a first prismatic block on the first surface such that a first facet of the first prismatic block is aligned to turn light emitted by the first light source toward the second surface;
positioning a second prismatic block on the first surface such that a second facet of the second prismatic block is aligned to turn light emitted by the second light source toward the second surface; and
positioning a third prismatic block on the first surface such that a third facet of the third prismatic block is aligned to turn light emitted by the third light source toward the second surface.

28. The method of claim 27, wherein the first color is different than the second color.

29. The method of claim 28, wherein the second color is different than the third color.

30. The method of claim 29, further comprising positioning the first prismatic block, second prismatic block, and third prismatic block to form a pixel that comprises the first prismatic block, second prismatic block, and third prismatic block.

31. The method of claim 27, further comprising bonding the first prismatic block, second prismatic block, and third prismatic block to the light panel with a coupling layer.

32. The method of claim 31, wherein the first prismatic block has a first index of refraction characteristic, wherein the second prismatic block has a second index of refraction characteristic that is about the same as the first index of refraction characteristic, wherein the third prismatic block has a third index of refraction characteristic that is about the same as the second index of refraction characteristic, wherein the light panel has an index of refraction characteristic that is about the same as the first index of refraction characteristic, and wherein the bonding agent has an index of refraction characteristic that is about the same as the first index of refraction characteristic.

33. A method of manufacturing a illumination system, the method comprising:
providing a light panel having a first surface, a second surface opposite the first surface, a first edge, and a second edge, the light panel having a first luminance characteristic; and
positioning a first luminance altering element on the first surface and a second luminance altering element on the first surface such that the light panel has a second luminance characteristic, wherein the second luminance characteristic is different than the first luminance characteristic.

34. The method of claim 33, wherein the first luminance altering element comprises an element selected from the group consisting of prismatic blocks, glues, adhesives, and bonding agents.

35. The method of claim 34, wherein the second luminance altering element comprises an element selected from the group consisting of prismatic blocks, glues, adhesives, and bonding agents.

36. The method of claim 35, wherein the first and second luminance altering elements comprise prismatic blocks.

37. The method of claim 33, further comprising:
positioning a first light source configured to emit light having a first color near the first edge of the light panel; and
positioning a second light source configured to emit light having a second color near the second edge of the light panel.

38. The method of claim 37, wherein the first luminance altering element is configured to turn at least a portion of the light emitted by the first light source toward the second surface.

39. The method of claim 38, wherein the second luminance altering element is configured to turn at least a portion of the light emitted by the second light source toward the second surface.

40. The method of claim 39, wherein the first luminance altering element is configured to turn more light emitted by the first light source than light emitted by the second light source, and the second luminance altering element is configured to turn more light emitted by the second light source than light emitted by the first light source.
